(19) United States
(12) Patent Application Publication
(10) Pub. No.: US 2012/0048704 A1
(43) Pub. Date: Mar. 1, 2012

(54) KEYCAP, KEYBOARD WITH THE SAME, JIG FOR PAINTING THE SAME

(75) Inventor: Ching-Cheng Tsai, Keelung City (TW)

(73) Assignee: CHICONY ELECTRONICS CO., LTD., Taipei County (TW)

(21) Appl. No.: 12/957,423

(22) Filed: Dec. 1, 2010

(30) Foreign Application Priority Data
Aug. 26, 2010 (TW) 099216499

(51) Int. Cl. H01H 13/76; B23Q 3/00; H01H 13/14

(52) U.S. Cl. 200/5 A; 200/341; 269/289 R

(57) ABSTRACT

A keycap is disposed on the plate of a keyboard. The keycap comprises a press surface, a hollow zone, a plate connection structure, a jig connection structure. The hollow zone is set on a side of the keycap opposite to the press surface. The plate connection structure is set in the hollow zone and used for connecting to the plate. The jig connection structure is connected to the jig when the keycap in a painting processing. Moreover, a keyboard and a jig for the keycap are also provided herein.

### RELATED APPLICATIONS

This application claims priority to Taiwan Application Serial Number 99216499, filed Aug. 26, 2010, which is herein incorporated by reference.

### BACKGROUND

1. Field of Invention

The present invention relates to a keycap. More particularly, the present invention relates to a keyboard with a keycap and a jig for painting the keycap.

2. Description of Related Art

The keycap of the keyboard could be moved vertically relative to the keyboard plate by the cooperation of the connected structures set on the keycap and set on the keyboard plate.

In some situation, the keycap is painted to provide a variety of looks. The keycap is mounted on the jig first, and then after the painting, baking, and printing process, the keycap is taken out from the jig and installed on the keyboard plate.

A conventional jig has a connected structure similar to the connected structure of the keyboard plate. Hence, the connected structure of the keycap can be connected with the connected structure of the jig to mount the keycap on the jig.

In order to reduce cost, the jig is reused repeatedly. However, after the painting and baking process, the size of the connected structure set on the jig could be changed. If the keycap is mounted on the jig which includes the changed size connected structure, the connected structure of the keycap is also out of shape. Hence, the painted keycap could not be installed on the keyboard plate stably. Furthermore, the painted keycap may disengage from the keyboard plate easily.

Therefore, how to solve the forging problem is an objective of the keyboard company.

### SUMMARY

In accordance with the foregoing and other objectives of the present invention, a keycap for a plate of a keyboard is provided.

The keycap comprises a press surface, a hollow zone, a plate connection structure and a jig connection structure. The hollow zone is set on a side of the keycap opposite to the press surface. The plate connection structure is set in the hollow zone and used for connecting with the plate. The jig connection structure is used to connect with the keycap when the keycap is in a painting process. Moreover, the plate connection structure is not direct connected to the jig when the keycap is in the painting process.

In addition, the jig connection structure does not interrupt a moving path of the keycap.

A jig for painting the keycap is also provided herein. The keycap comprises a mounting structure. The mounting structure is set on the jig relative to the jig connection structure and used for connecting with the jig connection structure to mount the keycap on the jig. There is a distance between the mounting structure and the plate connection structure when the keycap is mounted on the jig.

A keyboard is also provided herein. The keyboard comprises a plate and a keycap. The plate has a keycap connection structure. The keycap is set on the plate and capable of moving vertically relative to the plate. The keycap comprises a hollow zone, a plate connection structure and a jig connection structure. The hollow zone has an opening toward to the plate. The plate connection structure is set in the hollow zone and connected to the keycap connection structure so that the keycap is set on the plate and used for moving vertically relative to the plate. The jig connection structure is separated from the keycap connection structure with a distance.

In the embodiment of the invention, the keycap further comprises a jig connection structure. When the keycap is in painting process, the keycap is mounted on the jig by the jig connection structure. Therefore, in the painting process, the plate connection structure which is set for connecting with the plate is not connected to the jig directly. Hence, the shape/size of plate connection structure is not changed after the painting process. When the painting process is finished, the keycap is installed on the plate by the plate connection structure. It can reduce the disengaging probability between the keycap and the plate.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a cross-section view of one keycap assembly.

FIG. 2 illustrates a cross-section view of one keycap assembly.

FIG. 3 is a schematic diagram of a jig of an embodiment.

FIG. 4a to FIG. 4f are schematic diagrams of the connection between the keycap and a jig.

FIG. 5a and FIG. 5b are schematic diagrams of the keycap of embodiments.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

All embodiments of the invention include an additional connection structure for connecting with the jig, and the connection structure for connecting with the plate is not connected to the jig directly. Therefore, the shape/size of the connection structure for connecting with the plate is not changed in the painting process.

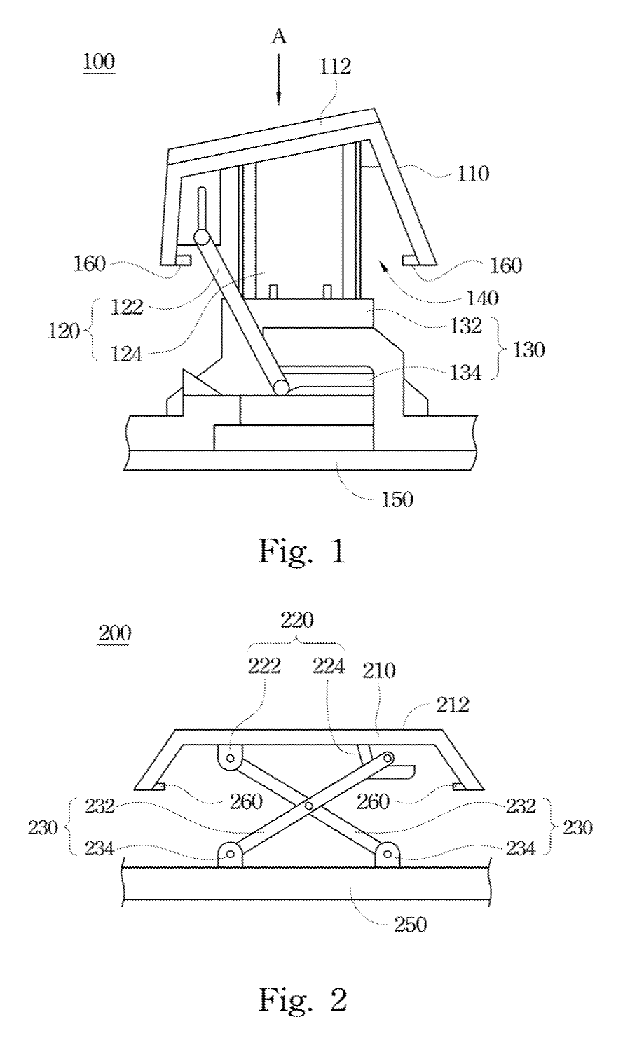

Please refer to FIG. 1. FIG. 1 illustrates a cross-section view of one keycap assembly. Keyboard 100 has a plate 150 and a keycap 110. The plate 150 includes a keycap connection structure 130. The keycap 110 is set on the plate 150. The keycap 110 could movie vertically relative to the plate 150 to form a moving path. The keycap 110 includes a press surface 112, hollow zone 140, a plate connection structure 120, and a jig connection structure 160.

The press surface 112 is a surface of keycap 110 which receives the force forced by the finger when the user types the keyboard. The hollow zone 140 is set on a side of the keycap 110 opposite to the press surface 112. The opening of the hollow zone 140 is toward to the plate 150. The plate connection structure 120 is set in the hollow zone 140 and connected to the keycap connection structure 130 which is set on the plate 150 so that the keycap 110 is installed on the plate 150. The jig connection structure 160 is used to connect on a jig when the keycap 110 is in a painting process. When the keycap 110 is installed on the plate 150, the jig connection structure 160 is separated from the keycap connection structure 130 with a distance, and not connected with the keycap connection structure 130 directly.

In the embodiment of FIG. 1, the plate connection structure 120 includes a controlling lever 122 and a cylindrical member 124. The keycap connection structure 130 includes a space 132 and a slide rail 134. One end of the controlling lever 122 is pivot jointed to the keycap 110, another end of the controlling lever 122′ is set in the slide rail 134. The space 132 holds the cylindrical member 124. When the press surface 112 receives a force toward to direction A, the controlling lever 122 moves in the slide rail, the cylindrical member 124 also moves alone direction A in the space 132. Therefore, the keycap 112 moves relative to the plate 150 and the moving path is formed.

There is a variety of ways to connect the plate 150 with keycap 110. Please refer to FIG. 2. FIG. 2 illustrates a cross-section view of another kind of keycap assembly. In this embodiment, the plate connection structure 220 of the keycap 212 includes a pivot member 222 and a guide member 224. The keycap connection structure 230 of the plate 250 includes two connected members 232 which are pivot with each other and a pivot member 234. The connected members 232 are connected to the pivot member 222, 234 individually and also connected to the guide member 224. Therefore, the keycap 110 moves relatively, when the press surface 212 of the keycap 110 receives a force.

The embodiments describe above is used to explain there is a variety of ways to connect the plate with keycap. Hence, the moving function and structure of the keyboard should be understood by someone skill in the art, and not further described herein.

It is important to note that besides the plate connection structures 120, 220, the keycap 110, 220 further includes jig connection structures 160, 260. The jig connection structures 160, 260 are connected to the jig, when the keycap 110, 210 are in a painting process. The jig connection structures 160, 260 are separated from the keycap connection structures 130, 230 with a distance, and not connected directly when the keycaps 110, 210 are installed on the plate 150. Moreover, the jig connection structures 160, 260 do not interrupt the moving path of the keycap 110, 210.

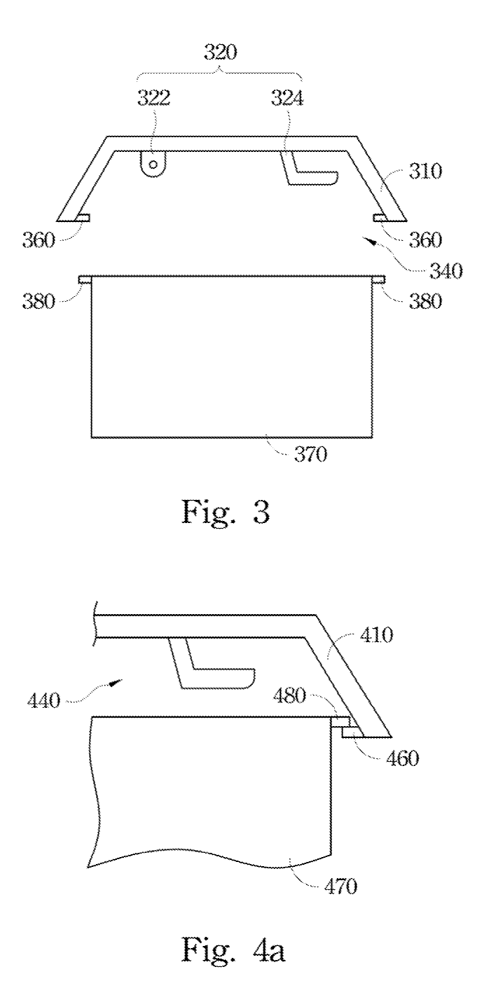

Please refer to FIG. 3. FIG. 3 is a schematic diagram of jig of an embodiment. The jig 370 is used to mount the keycap 310 described above. The jig 370 includes a mounting structure 380. The mounting structure 380 is set on the jig 370 relative to the jig connection structure 360. The mounting structure 380 is connected with the jig connection structure 360 to mount the keycap 310 on the jig 370. Moreover, there is a distance between the mounting structure 380 and the plate connection structure 320. The plate connection structure 320 is not connected to the jig 370 directly.

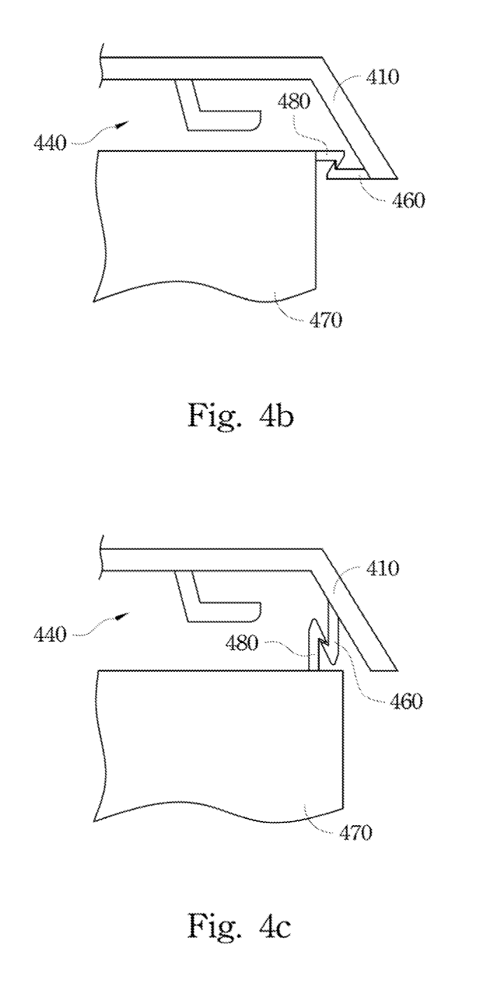

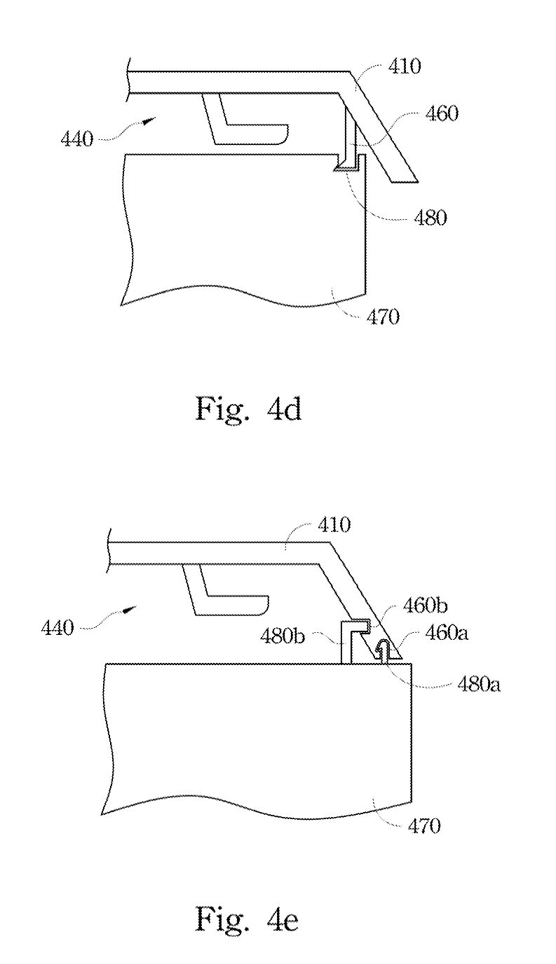

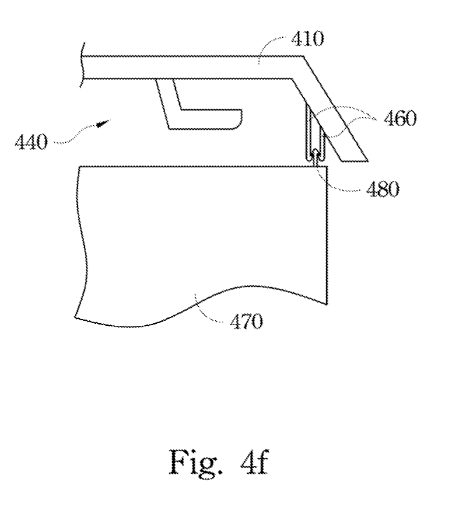

In order to explain the connection between the jig connection structure 360 and the mounting structure 380, please to FIG. 4a to FIG. 4f. FIG. 4a to FIG. 4f are schematic diagrams of the connection between the keycap and a jig.

In FIG. 4a, the jig connection structure includes a keycap projection member 460. The keycap projection member 460 is set on the circumference of the hollow zone 440 and stuck out to the hollow zone 440. The mounting structure includes a jig projection member 480. The jig projection member 480 is stuck out of the circumference of the jig 470 and used for lodging with the keycap projection member 460. Therefore, the shapes and positions of the jig connection structure and the mounting structure are corresponded with each other so that the keycap 410 is mounted on the jig 470 in the painting process.

In FIG. 4b, the jig connection structure includes a keycap hook member 460. The keycap hook member 460 is set on the circumference of the hollow zone 440 and stuck out to the hollow zone 440. The mounting structure includes a jig hook member 480. The jig hook member 480 is stuck out of the circumference of the jig 470 and used for lodging with the keycap hook member 460.

In FIG. 4c, the jig connection structure includes a keycap hook member 460. The keycap hook member 460 is set in the hollow zone 440. The mounting structure includes a jig hook member 480. The jig hook member 480 is set on a face of the jig 470 facing the hollow zone 440 and used for lodging with the keycap hook member 460.

In FIG. 4d, the jig connection structure includes a keycap hook member 460. The keycap hook member 460 is set in the hollow zone 440. The mounting structure includes a jig pit 480. The jig pit 480 is set on a face of the jig 470 facing the hollow zone 440 and used for lodging with the keycap hook member 460.

In FIG. 4e, the jig connection structure includes keycap pits 460a, 460b. The keycap pit 460a is set in the hollow zone 440. The keycap pit 460b is set in the circumference between the keycap 410 and the hollow zone 440. The mounting structure includes jig hook members 480a, 480b. The jig hook members 480a, 480b are corresponded to the keycap pits 460a, 460b respectively, and set on the face of jig 470 facing to the hollow zone 440. Therefore, the jig hook members 480a, 480b are used for lodging with the jig connection structure. In addition, the designer also could choose one of corresponded set of the keycap pits 460a, 460b and jig hook members 480a, 480b to apply in an embodiment.

In FIG. 4f, the jig connection structure includes two keycap snap members 460. The keycap snap members 460 are set in the hollow zone 440. The mounting structure includes a jig snap member 480. The jig snap member 480 is set on the face of the jig 470 facing the hollow zone 440 and used for snapping with the keycap snap members 460 together.

Accordingly, the plate connection structure of the keycap is not connected to the jig directly. The keycap is mounted on the jig through the connection between the jig connection structure and the mounting structure. Hence, the plate connection structure is not used in the painting process.

Moreover, the jig connection structure and the mounting structure are not limited in the embodiments described above. The designer could set other structure such as insert member on the keycap to mount the keycap on the jig in the painting process.

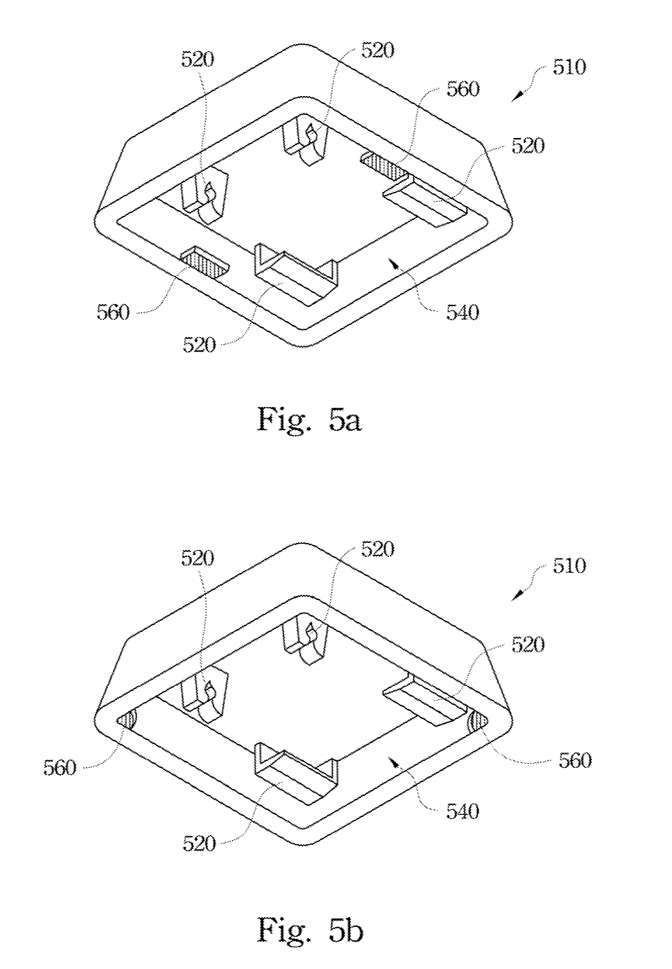

FIG. 5a and FIG. 5b are schematic diagrams of the keycap of embodiments. There are some examples to show the arrangement of the jig connection structure 560, if the jig connection structure 560 is set on the circumference of the hollow zone 540 of the keycap 510. In FIG. 5a, when the circumference of the hollow zone 540 is a square, the jig connection structure 560 could be set on the edges of the circumference. Moreover, in FIG. 5b, the jig connection structure 560 could be set on the included angle between two edges of the circumference. Hence, the jig connection structure 560 can be set on the circumference of the hollow zone 540 without any position limitation.

In the embodiments of the invention, the keycap further includes a jig connection structure. When the keycap is in painting process, the keycap is mounted on the jig by the jig connection structure. Therefore, in the painting process, the plate connection structure which is set for connecting with the plate is not connected to the jig directly. Hence, the shape/size of plate connection structure is not changed after the painting process. When the painting process is finished, the keycap is installed on the plate by the plate connection structure. It can reduce the disengaging probability between the keycap and the plate.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A keycap disposed on the plate of a keyboard comprising:
a press surface;
a hollow zone disposed on a side of the keycap opposite to the press surface;
a plate connection structure disposed in the hollow zone and capable of connecting with the plate; and
a jig connection structure capable of connecting with the jig when the keycap is in a painting process;
wherein the plate connection structure is not direct connected to the jig when the keycap is in the painting process.

2. The keycap of claim 1, wherein the jig connection structure does not interrupt a moving path of the keycap.

3. The keycap of claim 1, wherein the jig connection structure further comprises at least one keycap projection member disposed on the circumference of the hollow zone and stuck out to the hollow zone.

4. The keycap of claim 1, wherein the jig connection structure further comprises at least one keycap hook member disposed on the circumference of the hollow zone and stuck out to the hollow zone.

5. The keycap of claim 1, wherein the jig connection structure further comprises at least one keycap hook member disposed in the hollow zone.

6. The keycap of claim 1, wherein the jig connection structure further comprises at least one keycap pit disposed in the hollow zone.

7. The keycap of claim 1, wherein the jig connection structure is configured on the circumference of the hollow zone.

8. The keycap of claim 1, wherein the jig connection structure is configured on the edges of the circumference of the hollow zone.

9. The keycap of claim 1, wherein the jig connection structure is configured on the included angle between two edges of the circumference of the hollow zone.

10. A jig for painting the keycap of claim 1 comprising:
a mounting structure disposed on the jig relative to the jig connection structure and capable of connecting with the jig connection structure to mount the keycap on the jig;
wherein the mounting structure is separated from the plate connection structure by a distance when the keycap is mounted on the jig.

11. The jig of claim 10, wherein the mounting structure comprises at least one jig projection member stuck out of the circumference of the jig and capable of lodging with the jig connection structure.

12. The jig of claim 10, wherein the mounting structure comprises at least one jig hook member stuck out of the circumference of the jig and capable of lodging with the jig connection structure.

13. The jig of claim 10, wherein the mounting structure comprises at least one jig hook member disposed on a face of the jig facing the hollow zone and capable of lodging with the jig connection structure.

14. The jig of claim 10, wherein the mounting structure comprises at least one jig pit disposed on a face of the jig facing the hollow zone and capable of lodging with the jig connection structure.

15. A keyboard comprising:
a plate having a keycap connection structure; and
a keycap disposed on the plate and capable of moving vertically relative to the plate, the keycap comprising:
a hollow zone having an opening toward to the plate;
a plate connection structure disposed in the hollow zone and connected to the keycap connection structure; and
a jig connection structure separated from the keycap connection structure with a distance.
